(19) United States
(12) Patent Application Publication
(10) Pub. No.: US 2007/0192466 A1
(43) Pub. Date: Aug. 16, 2007

(54) STORAGE AREA NETWORK BOOT SERVER AND METHOD

(75) Inventor: Nelson NAHUM, Irvine, CA (US)

Correspondence Address: FRISHAUF, HOLTZ, GOODMAN & CHICK, PC, 220 Fifth Avenue, 16TH Floor, NEW YORK, NY, 10001-7708, US

(73) Assignee: STORAGE NETWORKING TECHNOLOGIES LTD., NESHER (IL)

(21) Appl. No.: 11/670,350

(22) Filed: Feb. 1, 2007

Related U.S. Application Data
(63) Continuation of application No. PCT/IL05/00822, filed on Aug. 2, 2005.

(30) Foreign Application Priority Data
Aug. 2, 2004 (IL) 163314

(51) Int. Cl. G06F 15/173

(52) U.S. Cl. 709/223

(57) ABSTRACT

A SAN Boot Server or SBS, and a method operative in association with a host boot SAN or BSAN) having hosts and devices coupled via network links to a network switch. The SBS stores a mapping of virtual volumes, each with one boot image. The SBS is coupled to the network switch and to the user network. The hosts have access to a virtual boot image when turned on, and each boot image directs each host to a storage device storing a booting program for booting the host. The hosts do not require, but may have an internal disk. The SBS is flagged for detection and differentiation, and each host has a modified host bus adaptor configured for fast discovery of a flagged SBS. There are groups of hosts having members, and when booting, each host accesses a specific boot image, which has a common portion and a host-specific portion, and each member shares the common portion.

The present application is a U.S. Continuation Application of International Application PCT/IL2005/000822, published in English, and filed on Aug. 2, 2005.

### TECHNICAL FIELD

The present invention is related in general to the booting of computers, such as hosts and servers of a Storage Area Network (SAN), and in particular, to the a device and a method for booting computers out of the storage devices of the Storage Area Network.

### BACKGROUND ART

FIG. 1 is a diagram of a conventional background art Storage Area Network (SAN) 100 having an array of hosts H, with H=H[1,2,3, . . . , h], and multiple disk arrays DA, with DA=DA[1,2, . . . , d], coupled in a storage network configuration by a network switch 15. The hosts H are coupled to the disk arrays DA via the network switch 15 by communication links 17, such as Fibre Channel (FC) communication links, or by other means pertaining to any other appropriate communication technology.

The network switch 15 is also known in the art as a network hub, a fiber channel network switch, a fiber channel switch, or a network channel switch.

Each host H has one or more HBA 19, and an internal disk 21, or hard disk 21, used to boot the host H.

The multiple disk arrays DA are coupled to the network switch 15 via one or more disk controllers CTRL, designated as CTRL=CTRL[1,2,3, . . . , c] but not shown in the drawings. Each disk array DA has a WWN (World Wide Number) and a series of LUNs (Logic Unit Numbers) numbered as LUN=LUN[0,1,2, . . . , l], which are presented to the many hosts H for storage purposes.

The SAN-attached disk arrays DA are used to store data, while the internal hard disk 21 is used in general for booting the host H, to store the Operating System (OS) and other software programs necessary for booting.

In general, the SAN-attached storage disk arrays DA are fault tolerant, since they have redundant disks, redundant controllers, and the like, and also provide better performance than internal disks 21. This is why data is stored on the disk arrays DA.

In contrast, an internal disk 21 is very prone to mechanical failure, and provides rather poor performance when compared to a disk arrays DA. Therefore, internal disks 21 are used only for the purpose of booting the hosts H, and for storing computer programs and information that does not change too often, like operating systems, software programs, computer settings, and the like.

When an internal disk 21 fails, the host H is likely to crash, and it may take hours to rebuild such an internal disk 21 by help of a backup tape, or by reloading software packages and recreating the disk's settings.

Attempts have been made to boot from SAN-attached devices but resulted generally in lengthy procedures always requiring manual intervention, or in complex configurations due to the problems caused by the multiple paths of the storage devices.

US Patent Application Publication No. 2004/0243796, by Keohane, Susann, et al., discloses a method, an apparatus, and a program for performing operations on a machine connected to a Storage Area Network. Means are disclosed for sending a boot device query to a storage area network appliance, and for receiving a list of boot devices from the storage area network appliance. Then, at least one boot device in the list of boot devices is configured; and next, the machine is booted from the at least one boot device.

US Patent Application Publication No. 2005/0083749, also by Keohane, Susann, et al., discloses, in a SAN computer system having a volume group made up of one or more physical disks, a method for providing SAN boot devices, said method comprising: storing a boot image from a boot device on at least one disk within said volume group; subsequently booting the SAN system from the boot image stored on the at least one disk, wherein the SAN system's boot operation is completed from within said logical boot volume.

The two US Patent Application No. 20040243796, and No. 20050083749 refer to a SAN appliance that provides a query mechanism, and a way to replicate boot disks, but still require to manually enter the WWN of the physical disks on the host side.

Furthermore, the host computers programs for the boot image are loaded from the appliance console, requiring the Operating System of the hosts and the appliance to be identical. These two patents applications do not provide mechanisms for using templates in order to accelerate the deployment of new boot images as well as patch management with roll back options to accelerate the tests and deployment of new patches.

A method and a device for booting hosts from SAN-attached storage are advantageous for the following reasons.

1. SAN-attached disk arrays are much more reliable than internal disks.

2. It is much easier to manage a system of centralized storage devices equipped with sophisticated management command functions than hundreds or even thousands of internal hard disks dispersed in hundreds or thousands of hosts.

3. There is created a “diskless” host that is not only much cheaper, but also less voluminous, consumes less power and produces less heat than conventional hosts. It is well known that the internal disk of a host is one of the most expensive parts, takes up a lot of space, consumes most of the power, and delivers most of the heat.

4. In the case of hardware failure of a host, recovery is easy, just by replacing the hardware and by rebooting from the same SAN-attached disk, which saves great amounts of time.

5. SAN-attached disks for reboot are customized to provide the exact size of memory needed, as opposed to internal disks that have a fixed size, causing in general a waste of a lot of memory space.

6. The SBS-attached devices may have, advanced copy capabilities that permit to create instant copies of the boot disks, for quick deployment of additional hosts, as opposed to the need for reloading each time all the software components from the CD-ROMs, which is not only very time-consuming process, but also renowned to be error prone.

7. In general, SAN-attached devices have a remote copy function, allowing to produce an exact image of the boot device operative in a first site, to be readily available at a remote site.

It is thus desirable to provide a method, a device, and a server for automatically booting from a SAN, avoiding, prior to boot, for configuring, and loading a WWN into a server's HBA. Furthermore, it is required that the booting means be not restricted to a specific operating system, and to be operative with a non-homogeneous aggregation of servers.

### SUMMARY

The problem to be solved concerns the steps that must be taken to boot a host H, networked in a SAN, from the storage devices pertaining to the SAN. Commonly, the boot process begins when the host H is turned on, and starts searching for an internal disk 21. Once found, the host H searches for the MBR (or Master Boot Record) that is a small piece of software placed at the beginning of the internal disk 21. If no internal disk 21 is found, then the host H starts a search for the basic I/O system, or BIOS (Basic Input/Output System), of the various HBAs (Host Bus Adapters). The BIOS is the computer program code that is stored in the HBA and allows use of the disks connected to the particular HBA. Once the BIOS is operative, control is passed from the host H to the BIOS, which in turn tries to discover an attached hard disk device 23, to discover if one of them contains the MBR. In the description below, reference to an internal disk 21 is regarded as including any attached hard disk(s) 23, which are not shown in the Figs. When the MBR is found, in either on one of the internal disks 21 or in one of the hard disks 23 attached to one of the HBAs, the host H boots and starts running the specific code necessary to actually load the operating system. While loading the operating system, the device drivers of the HBA are also loaded, which allows the start of a search for the SAN-attached storage devices. Once these last ones are identified, then the device driver for operating the particular storage disk array DA is loaded too.

The problems presently arising when attempting to boot hosts H from a SAN are described below, and explain why internal disks 21 are still used for booting.

1. A SAN is possibly coupled to dozens or even hundreds of disk arrays DA, creating a potential for problems that may occur during the search for the discovery of the specific storage device containing the master boot program MBR. This problem is especially acute when a new disk array DA or a new storage device is coupled to the SAN. In contrast, the HBA of a host H is coupled to only one or at most a few internal disks 21, usually less than eight.

2. The BIOS code is contained in the HBA itself, and as opposed to a software device driver, the BIOS code is difficult to update because it requires updating of the internal flash memory of a card, instead of updating the device drivers that are part of the operating system. Therefore, most of the HBAs still contain a rather “obsolete” piece of BIOS firmware that becomes a potential cause of problems, especially so when new SAN devices are coupled to the network. When an HBA operates in association with a disk array DA after being booted, and only for data handling, the BIOS is usually not operative and the software program running the HBA is the device driver loaded within the Operating System. The program code of a device driver is much easier to keep up to date than the BIOS code.

3. Most of the SAN-attached disk arrays DA have high availability schemes that are “vendor proprietary”. Thus, to be able to boot from one of those disk arrays DA, the BIOS should be configured to include software programs that are able to operate at least most if not all of the many existing different non-homogeneous disk arrays DA, as supplied by the different vendors. Such a solution is totally impractical.

4. Since the many disk arrays DA attached to a SAN are shared among multiple hosts H, security features like LUN masking and LUN zoning are applied, to prevent mutual corruption of the storage devices. For this reason each time a machine, such as a host H, or a computer with an HBA are added to the SAN, it is necessary to enable that machine at the storage array and/or at the network switch 15. This enablement process, which is performed manually, is not only very time consuming but also highly prone to error. Such a situation is in contrast with the features of an internal disk 21 void of security provisions, to the contents of which only one host H is attached and has access. Since the internal disk 21 is obviously internal to the host H, security risks are non-existent, making the need for security settings superfluous.

5. The contents of an internal disk 21 are quite static and in general, are found to be very similar from host to host. For example, a site with 100 hosts H, where each host requires 10 GBs of memory space for the boot process, will have almost 1000 GBs or 1 TB of almost identical and very static contents. Because SAN-attached disk arrays DA are more expensive by an order of magnitude than internal disks 21, maintaining that capacity of 1 TB in SAN-attached disk arrays DA is a pure waste of money.

6. The process of loading the complete O.S. for the first time into the boot device is very time consuming and in general, requires only a “minimal” operating system to run the O.S package residing in the one or more CD-ROMs. This minimal O.S. is unable to deal with the complexities of the disk arrays DA, and especially not with the complexities of multiple paths and High Availability. In contrast, the internal disk 21 has but one path, without multiple paths and high availability options. Presently therefore, when it is desired to boot a host H from a SAN, no additional process steps are required, such as for the disablement during the loading of the O.S. of the hosts H, of the multiple paths and High Availability option functions.

For the reasons enumerated above, it is presently not very practical to boot hosts H from SAN-attached disk arrays DA. The complexity of such a SAN-based boot process is not worth the effort, as the process is time consuming, very tedious, and therefore, highly prone to error.

The solution is provided by the following means.

First, there is provided a SAN Boot Server, or SBS, for virtualization, snapshooting, and replication tasks. The SBS is coupled directly to the network switch 15 and is configured to show a flag for detection by an appropriately modified HBA of a host H. When a host H is turned on for operation, the modified HBA will search the SAN only for a flagged SBS. Once found, the SBS directs each single host H to a host-specific boot image wherefrom the computer programs necessary to boot the host H are loaded, for the host H to boot and become operative. Booting of a host H is achieved without the need for an internal hard disk.

Second, the booting computer programs are dissociated into two distinct portions. A booting computer program is regarded as having a large common portion, and a small host-specific portion, or specific portion. The common portion contains all the programs common to a group of hosts of say, the same type, or the same vendor, such as having, for example, the operating system, drivers for devices, and the like, in common to a homogeneous group of hosts H.

Since the host-common portion is common to a group of hosts H, possibly including dozens and hundreds of hosts, it is sufficient to store one copy of the common portion for access by all the members of the group. Thereby, a huge amount of storing space is saved.

The host-specific portion relates to the attributes, authorizations, and other computer programs particular to each individual host H, such as, for example, the IP address of the host. The host-specific portion is generally very small relative to the common portion.

Third, by help of a System's Administrator workstation running a GUI, the SBS is operated to boot hosts H, to modify booting computer programs, and to test boot patches without the need to access a host H. Should a tested patch not be satisfactory, then the tested patch is simply rolled back.

It is an object of the present invention to provide a SAN Boot Server (SBS) (35) and a method for operation in association with a host boot SAN or BSAN. The BSAN has a plurality of hosts and of physical storage devices, coupled via network communication links to a network switch, the hosts being further coupled to a user network supporting user workstations. The SAN boot server SBS stores a mapping of virtual volumes, with each virtual volume containing one boot image. The SBS is coupled to the network switch and to the user network, and the hosts are configured to access a virtual boot image when turned on to become operative. The boot image directs each host out of the plurality of hosts to at least one storage device storing a booting computer program for booting the host, whereby the hosts are booted automatically from at least one storage device when turned on to become operative.

The hosts coupled to the BSAN are booted thereby when configured as either one of both, void of an internal disk and with an internal disk.

It is another object of the present invention to provide an SBS flagged for detection and for differentiation, where each host has at least one modified HBA configured to discover a flag of an SBS, and when turned on to become operative, the at least one modified HBA is configured to search the BSAN for discovery only of an SBS. Furthermore, each host is configured to search the BSAN for discovery only of an SBS, which directs the HBA to a WWN/LUN address wherein a booting computer program is stored and from which the host is booted.

It is yet another object of the present invention wherein when the SBS and the hosts are turned on, to provide at least one host configured to search for the SBS, and when the SBS is discovered, to access, via virtual volume mapping stored in the SBS, of an appropriate boot image directing to a booting computer program, and to boot from the booting computer program stored in at least one storage device.

It is still another object of the present invention to provide a plurality of hosts that include groups of hosts having group members, and when booting, each one host out of the plurality of hosts accesses a host-specific boot image, and each one member of a group shares one same boot template computer program common to the group. One SBS may be provided for one group of hosts.

It is yet still another object of the present invention to provide a plurality of hosts including groups of hosts having group members, and when booting, each one host out of the plurality of hosts accesses a host-specific boot image. Moreover, each boot image has a common portion and a host-specific portion, and each one member of a group shares the common portion, which is common to all the members of the group.

It is yet an additional object of the present invention to provide a plurality of hosts that include groups of hosts having group members. When booting, each one host out of the plurality of hosts accesses a booting computer program having a common portion, which is a template of the boot image, and a host-specific portion, and each single one member of a group shares a common portion, which is common to all the members of the group.

It is yet a further additional object of the present invention to provide a single copy of the common portion to which the members of a group have access and sufficing as the common portion necessary for booting members of the same group.

It is one more object of the present invention is to provide for that, when a boot image is unavailable to a host, the host will be directed to boot from a computer program stored in either one of both, at least one storage device coupled to the BSAN, and a disk internal to the host.

It is a further object of the present invention to provide a host to which the SBS is coupled and has a HBA which is modified to search for and discover only an SBS, and to access an appropriate boot image mapping stored therein, the SBS directing to a computer booting program which boots the host, whereby a host is booted and manual access to the host is avoided.

It is yet a further object of the present invention to provide a SBS that has a first coupling linked to the network switch, and has a second coupling selected alone and in combination, from the group consisting of coupling the SBS to the user network, coupling the SBS to an Internet to which the BSAN is also coupled, and coupling the SBS to a workstation.

It is still an additional object of the present invention to provide at least one additional SBS is coupled to the SBS, for the purpose of redundancy and for recovery from failure. For the same purpose, the boot images and the boot computer programs are asynchronously mirrored to a remote SAN site.

It is still a further object of the present invention to provide a workstation operated by a system administrator and running a GUI, which is coupled to the BSAN, and where the GUI is operated in association with the SBS for allowing booting of the hosts from the BSAN, and for testing and assigning patches for updating host booting computer programs.

It is still one more object of the present invention to provide a host that is booted via a boot image directing to an operative booting computer program, and with the GUI being operated to create and test a patched booting computer program providing updates to the operative booting computer program. When the test is successful, the operative booting computer program is replaced by the patched booting computer program, which is then committed, and when the test fails, the patched booting computer program is rejected.

It is one other object of the present invention to provide a method and a SAN Boot Server or SBS, operative in association with a host boot SAN or BSAN, having a plurality of hosts and of storage devices, coupled via network communication links to a network switch. The hosts are further coupled to a user network supporting user workstations, and forming groups of hosts, each group having at least one group member, where the SBS is coupled to the network switch and to the user network. The hosts, when turned on to become operative, are configured to access an SBS wherefrom each host out of the plurality of hosts is directed to a boot image containing common and host-specific computer programs for booting the host. A mapping of virtual volumes is stored in the SBS, with each virtual volume containing one boot image for one host, which is directed by the SBS to at least one storage device storing computer programs for booting the host, whereby the hosts are booted automatically from at least one storage device when turned on to become operative.

It is furthermore an object of the present invention to provide a method and an SBS wherein a boot image has one common portion directing to a boot template storing a booting computer program common to all members of a group, and one host-specific portion containing data which is specific to one host. The SBS is configured for execution of commands, for system management tasks, and for creation of boot templates and of boot images. A workstation, operated by a system administrator running a GUI for providing management commands is further coupled to the SBS, whereby creation of boot templates and of boot images for quick deployment of additional hosts is available.

It is an additional object of the present invention to provide a method and an SBS configured for creation of boot templates and boot images, and for testing patches of booting computer programs, wherein the system administrator runs tests of patches via the SBS, and according to performance, commands the SBS to either one of both, accept and commit patches, and roll-back and reject patches.

It is a final object of the present invention to provide a method and an SBS wherein the system administrator is remote from the hosts when entering commands to the SBS, via the workstation.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a diagram representing a background art SAN facility,

FIG. 2 is a diagram depicting a SAN-Booted SAN facility,

FIG. 3 is a block-diagram illustrating a SAN-Booted Server,

FIG. 4 is a flowchart of a host booting process,

FIG. 5 is a flowchart of a boot template creation procedure,

FIG. 6 is a flowchart of a boot image creation procedure,

FIG. 7 is a flowchart of a patch creation and testing procedure,

FIGS. 8, 9 and 10 show detailed steps of FIG. 7,

FIG. 11 illustrates results of the process described with reference to FIG. 10,

FIG. 12 shows details of the commitment of the patch boot image, and

FIG. 13 depicts results of the process described with reference to FIG. 12.

### BEST MODE FOR CARRYING OUT THE INVENTION

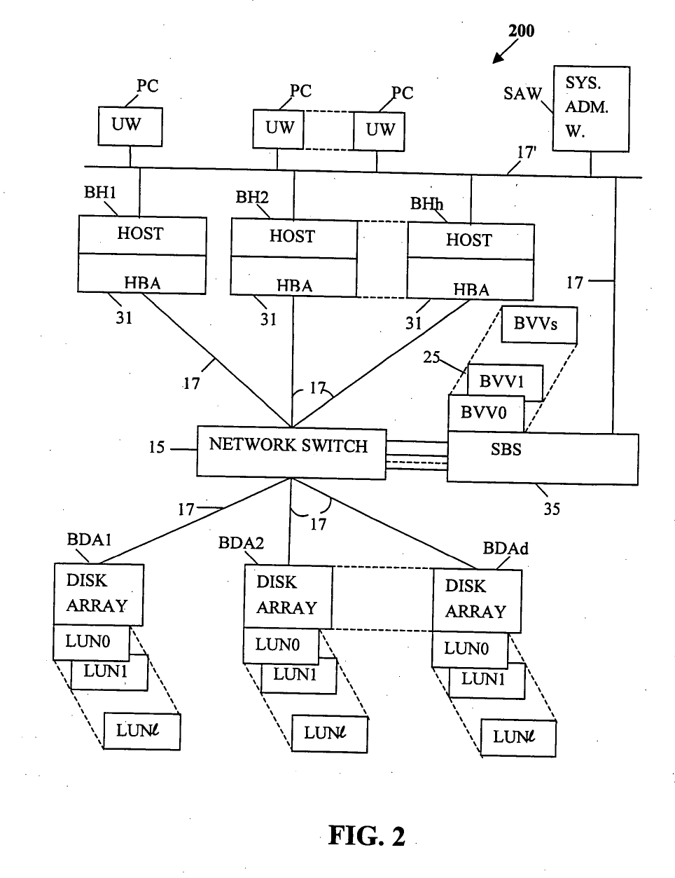

FIG. 2 is a diagram of an embodiment 200 illustrating a server, a method, or a facility configured for booting from a SAN. Such a facility is referred to as a host boot SAN, or BSAN.

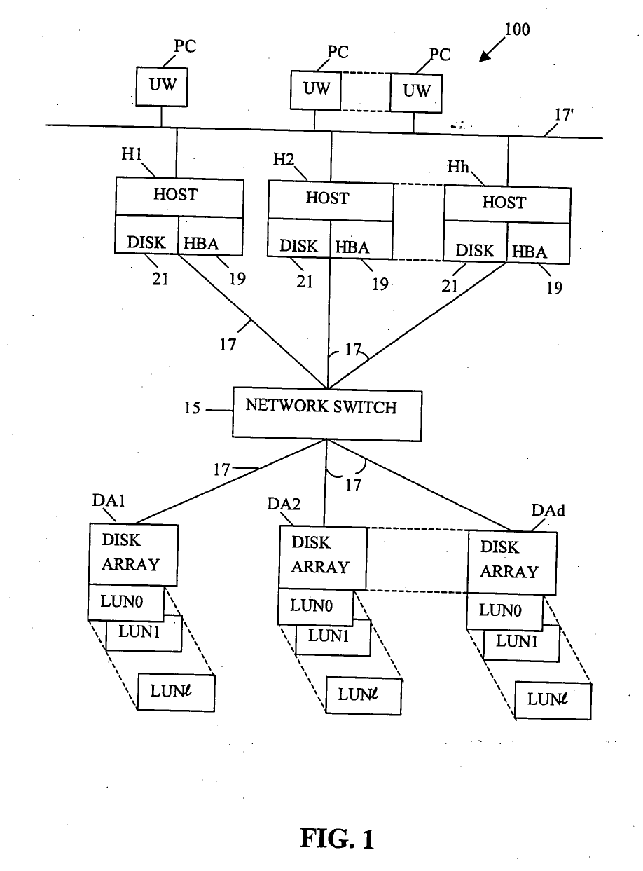

In a BSAN the plurality of hosts BH are booted into operation by a booting procedure using a computer program package saved in one or more storage devices BDA pertaining to the BSAN. This is in contrast with booting from an internal hard disk, or an internal disk 21, internal to the host H, as shown in FIG. 1.

The BSAN has an array of hosts BH, with BH=BH[1,2,3, . . . , h], where each host BH is configured like a conventional host H, except for the lack of an internal disk 21. Each host BH coupled to the BSAN has at least one host bus device 31, or BHBA 31, but may be void of, or is not required to contain the internal disk 21 shown in FIG. 1. This means that the BSAN tolerates, and will operate with regular hosts H having an internal disk 21, but that the internal disk 21 is not necessary for host BH booting purposes. In other words, hosts coupled to the BSAN are booted thereby when configured as either one of both, void of an internal disk and with an internal disk.

In the description hereinbelow, hosts BH may include computers, servers, workstations, PCs, and other computer facilities, not shown in the Figs., all being machines configured to execute instructions set forth in a computer program encoded on a computer-readable medium.

Multiple storage devices, preferably disk arrays BDAs, but possibly other storage devices if desired, are coupled to a network switch 15. The disks arrays BDA, identified as BDA=BDA[1,2, . . . , d], are coupled to the hosts BH in a storage network configuration, via the network switch 15, and are connected by network communication links 17, such as fibre optic Fibre Channel (FC) communication links, or by other means pertaining to any other appropriate communication technology.

FC communication links also support, for example, multimode fibre connections, coaxial cables, and twisted-pair cables. The SAN communication network is possibly implemented, for example, as a LAN (local area network), a WAN (wide area network), an Intranet, or an Internet or as the new SAS interface (Serial Attached SCSI).

In the description hereinbelow when reference is made to storage devices BDA, disk arrays are preferred, but are an example only of other known storage devices, such as tape drives, optical drives, and the like, all having a physical structure providing a computer memory for storing computer programs.

As common with conventional SAN facilities, the plurality of disk arrays BDA, are coupled to the network switch 15 via one or more disk controllers CTRL, designated as CTRL=CTRL[1,2,3, . . . , c], which are not shown in the Figs. for the sake of clarity.

Each disk array BDA, is associated with one single identifying World Wide Number WWN, and each single disk of a disk array BDA is identified by a Logical Unit Number LUN. The storage devices are made available to the hosts BH for various purposes, such as for example, some for data processing, while others are allocated to the booting of the BSAN.

In FIG. 2, a SAN Boot Server 35, or SBS 35, is shown coupled by a first coupling to the network switch 15, by one or more communication links 17, preferably by Fibre Channel (FC) communication links. Although not shown in the Figs., to avoid multipathing problems, each BHBA 31 pertaining to a host BH is coupled to the SBS 35 by a single network path 17. The SBS 35 is coupled by a second coupling to the user network 17′, to which the hosts BH and user workstations PC are coupled.

An SBS 35 coupled to a BSAN is configured to display a flag when operative. That flag is discovered by the BHBA 31, which is configured to detect only flagged SBS 35 devices. Therefore, when turned on to operate, the BHBA 31 of a host BH will search the BSAN but only to detect a device such as a flagged SBS 35. That search is fast since it is limited to one or to a single few devices. Once found, each host BH is automatically coupled to the SBS 35.

In other words, the SBS is flagged for detection and for differentiation. Each host has at least one modified HBA (BHBA) configured to discover the flag of an SBS, and when turned on to become operative, the at least one modified HBA is configured to search the BSAN for discovery only of an SBS, which directs the HBA to a WWN/LUN address wherein a booting computer program is stored and from which the host is booted.

In FIG. 2, a System Administrator SA is provided with a workstation SAW coupled to a user network 17′ to which the hosts BH and user workstations PC are also coupled. If desired, the workstation SAW is coupled only to the SBS 35, or only to the user network 17′ as shown in FIG. 2, or only to an Internet to which the SBS 35 is coupled, or to both the user network 17′ and to the SBS 35.

The System Administrator SA uses a graphic user interface, GUI, not shown in the Figs., to manage and control operations via his System Administrator workstation SAW. Such operations include, for example, commanding virtualization, snapshooting, mirroring, replication, the creation of virtual volumes, of booting templates, of boot images, and the testing of boot patch computer programs. Likewise, the System Administrator SA may operate via any user workstation coupled to the SAN, which is provided with the necessary authorizations.

Various types of devices to be attached to a network switch 15, are divulged by the present inventor in U.S. Pat. No. 6,898,670, and in the patent applications published as US Patent Application Publication Nos. 2004-0078599A1 and 2005-0177693A1 the entire disclosure of all three of which are incorporated herein by reference. Coupling, operation, and implementation of the SBS 35 is similar to that of the Storage Virtualization Manager SVM 3 described in the above-referenced incorporated U.S. Pat. No. 6,898,670.

Optionally, the SBS 35 may be integrated within the network switch 15, or coupled only to the user network 17′, which couples hosts and user workstations PC to the network switch 15. Possibly, the SBS 35 is integrated within a System Administrator Workstation SAW, or a user workstation PC, or coupled to the Internet to which the BSAN is also coupled. If desired, the SBS has a combination of coupling possibilities that may also be implemented as selected alone and in combination, from the group consisting of coupling the SBS to the user network, coupling the SBS to an Internet to which the BSAN is also coupled, and coupling the SBS to a workstation.

Preferably, for booting hosts BH from the BDAs of the BSAN, virtual volumes of memory, also called logical volumes, are created by virtualization of physical disk storage into virtual storage. Virtual volumes, are created, expanded, and stored by the SBS 35, according to the disclosure detailed in the incorporated U.S. Pat. No. 6,898,670. Such virtual volumes are created by the SBS 35 itself, or optionally, by other virtualization means, external to the SBS 35. The virtual volumes 25 are mapped in the SBS 35, and mappings are designated as BVV=BVV[0, 1, . . . , s].

The booting computer programs for each host BH are stored in virtual volumes VVs, say in at least one BDA and in at least one virtual volumes VV, the mapping of which is stored in the SBS 35. A booting computer program is contained in a boot image, which is considered as having two distinct portions, namely a large common portion, and a small specific portion, which is a host-specific portion.

The common portion contains all the programs common to a group of hosts of say, the same type, or the same vendor. For example, such as a homogeneous group of hosts BH having in common the operating system, drivers for devices, and the like. Hosts BH booting from a common booting computer program are viewed as a group of homogeneous hosts.

A group of hosts BH may include dozens and hundreds of hosts, but it is sufficient to store one only copy, or more for the sake of redundancy, of the common portion of computer programs to which all the members of the group will access. Since all the hosts of the group will boot from the common portion, a huge amount of storing space is saved. The common portion of booting computer programs, for booting a group of hosts BH is referred to as a template. Once created, the template is closed as Read Only.

The host-specific portion is individually associated with each host BH and contains the attributes, authorizations, and data specific to each individual host BH, such as, for example, the IP address of the host. The specific portion is generally very small relative to the common portion. For the specific portion, both Read and Write operations are authorized.

The boot images loaded with the set of computer programs for booting a host BH includes two portions, that is a common portion, also referred to as boot template, or simply as template, and a specific portion. One template and one specific portion are considered as a boot image sufficient to boot one host BH, and although one template is common and shared by a common group of hosts BH, one specific portion is required for each single host. Therefore, one same template will be reduplicated for the creation of multiple boot images. There will be at least as many templates as there are groups of hosts BH.

Prior to booting a host BH, the System Administrator SA will load a boot image in each virtual volumes 25, the mapping of the virtual volumes 25 being stored in the SBS 35. Then, when turned on to operate, a host BH will automatically discover the SBS 35, be directed via the virtual volume 25 to one or more disk arrays BDA physically storing the boot image, from where the host BH will boot, as described hereinbelow. The host BH will load an appropriate and compatible Operating System, and additional computer programs if desired, and then, automatically boot.

For booting purposes, a host BH first detects an SBS 35, via which booting will proceed. When a host BH is turned on from the turned off state, the BIOS of the BHBA 31, referred to as the BBIOS but not shown in the Figs., becomes operative. The BHBA 31 is the parallel of HBA 19 shown FIG. 1. The BBIOS is provided with a feature for detecting a dedicated flag displayed by an SBS 35. This feature allows the BBIOS to perform a restricted search of the devices coupled to the SAN, limiting that search to discover only SBS devices currently available in the BSAN.

Thereby, at boot time, discovery of all the SBSs 35 available on the SAN is fast and easy. An exhaustive search for the discovery of SBSs 35, requiring to scan every single device available on the whole BSAN, is thus avoided, and apart from being lengthy, such a search holds a potential for problems. Such problems relate to BSAN operation failures, caused mainly by devices lately added to the BSAN at the time of rescan, and by potential interoperability problems.

Another problem encountered by the background art methods for booting hosts H from a SAN is the need for the user to physically access and manually load the HBA BIOS of every single host H with the WWN/LUN, which is the unique identifier of the disk array DA, from which it will be booted. Should the user want to change the previously selected storage device DA from which a host H was set to boot from, he is then required to again access that host H and manually enter the new WWN/LUN.

According to the present invention, and prior to booting, the BBIOS disposed in the BHBA of a host BH will negotiate with the SBS 35 from what boot image to boot, thereby avoiding all the manual steps required by the background art when configuring an HBA to boot from the SAN. Furthermore, SBS 35 management facilities permit to remotely replace the boot image of any host BH, without requiring to physically access the BBIOS of the BHBA, and without requiring to manually enter the WWN/LUN identifying the device to boot from.

Generally speaking, the SBS 35 is built, performs, and is operated as the Storage Virtualization Manager SVM 3 described in the above-referenced incorporated U.S. Pat. No. 6,898,670. Therefore, a method and a SAN Boot Server (SBS) (35) may automatically boot hosts when operative in association with a host boot SAN (BSAN) (200) having an array or a plurality of hosts (BH) and of physical storage devices (DAB), coupled via network communication links (17) to a network switch (15), with the hosts being further coupled to a user network (17′) supporting user workstations (PC). The SAN Boot Server, SBS, stores a mapping of virtual volumes (25), with each virtual volume containing one boot image, and the SBS being coupled to the network switch (15) and to the user network. The array of hosts is configured to access a virtual boot image when turned on to become operative, and the boot image directs each host out of the plurality of hosts to at least one storage device storing a booting computer program for booting the host. Thereby the hosts are booted automatically from at least one storage device when turned on to become operative.

Furthermore, when the SBS and the hosts are turned on to become operative, a host is configured to search for the SBS, and when the SBS is discovered, to access via virtual volume mapping stored in the SBS, of an appropriate boot image directing to a booting computer program, and to boot from the booting computer program stored in at least one storage device. The plurality of hosts may include groups of hosts having group members, so that when booting each one host out of the plurality of hosts accesses a host-specific boot image, and each one member of a group shares one same boot template computer program common to the group. If desired, one SBS is provided for one group of hosts.

Thus, the plurality of hosts may include groups of hosts having group members, so that when booting each one host out of the plurality of hosts accesses a host-specific boot image, each boot image having a common portion and a host-specific portion, and each one member of a group sharing the common portion, which is common to all the members of the group. The common portion is the template of the boot image that is common to all the members of the group. A single copy of the common portion to which the members of a group have access suffices as the common portion necessary for booting members of the same group.

However, when a boot image is unavailable to a host, the host will be directed to boot from a computer program stored in either one of both, at least one storage device coupled to the BSAN, and a disk internal to the host.

A host to which the SBS is coupled has a BHBA BBIOS, which is modified to search for and discover only an SBS, and to access an appropriate boot image mapping stored therein, the SBS directing to a computer booting program which boots the host. Thereby convenience of operation is provided since a host is booted while manual access to the host is avoided.

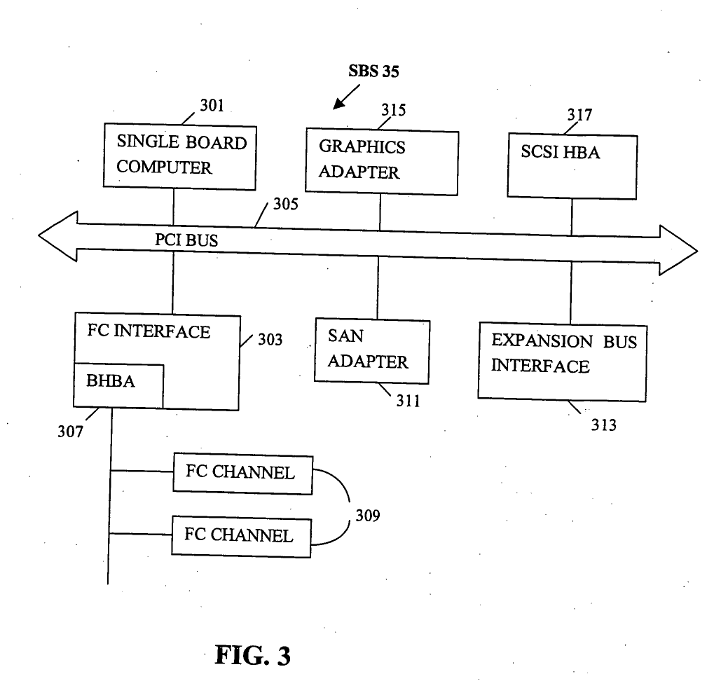

FIG. 3 is a block-diagram of the SBS 35, for an FC storage network, as an example only. The SBS 35 has a standard Pentium-based Single Board Computer 301 coupled to a Fibre Channel Interface Board 303 via a PCI bus 305. An intelligent BHBA (BSAN Host Bus Adaptor) module 307, on the Fibre Channel Interface Board 303 has dual FC channels 309 for the sake of redundancy.

The Single Board Computer 301 runs for example, a Windows 2003 Operating System featuring a built-in web-server for communication with the System Administrator in charge of the operation of the system. (Windows and Windows 2003 are Registered Trademarks of the Microsoft Corporation). It is noted that implementation is possible using any other O.S. like Linux, Unix or the like.

Other modules, such as a SAN adapter 311, an expansion bus interface 313, a graphics adapter 315, a SCSI HBA 317, and other adapters and interfaces may also be coupled to the PCI bus 305.

The SAN Boot Server 35 allows the System Administrator SA to operate at least, real time operating systems and device drivers, storage virtualization computer programs, snapshot and replication modules, and a graphical user interface GUI. These abilities are described in detail in the above-referenced incorporated U.S. Pat. No. 6,898,670.

Virtual Memory Partitions

Presently, most of the modern Operating Systems use Virtual Memory. Basically, this means that these modern Operating Systems use only a portion of the memory contents of their physical disks, and continuously swap memory pages back and forth from RAM to disk. The partitions or files, which are portions of the internal disk dedicated to memory swap, are usually called “Swap partitions” or “Swap files”. For different reasons, amongst them the necessity to operate the virtual memory early in the process of booting the hosts H, those partitions are conventionally placed in the boot device in the internal disk 21. As those partitions hold actual memory, the swap partition operations have a detrimental influence on the performance of the host H and on the execution of applications programs. By allowing the swap partitions to be stored in the high performance SAN-attached disk arrays DA, instead of being saved in the small and less reliable internal disks 21, the operational performance of the application program is dramatically enhanced.

Multiple Boot Images Sharing the Same Space

Since boot images are created by making instant low capacity snapshot copies of the boot templates, it is possible to create multiple boot images that actually share a same storage space. In other words, it suffices to save one boot template for common use by hosts BH that use the same boot template.

This capability saves significant amounts of storage space, especially in environments with a large number of hosts. For example, some 100 hosts BH booting each from a 20 GBs internal disk 21 will need a storage capacity of 2000 GBs, while actually, just 20 GBs could suffice when the same template is used on the SBS 35 to boot those 100 BH hosts.

In operation, the System Administrator SA may assign storage space to the SBS 35 by indicating LUNs of the disk arrays BDA. The SBS 35 uses the built-in storage virtualization computer programs to partition the indicated LUNs into small portions of memory, which become the virtual volumes that will store boot images. The snapshot and replication modules are used for the creation of boot images, and to commit and roll-back patches on the boot images.

The SBS 35 also supports mirroring as well as security and host identification modules, operating as described in the above-referenced incorporated patent applications published as WO02/071224A1, and WO03/017022A2.

Booting

In broad terms, to boot a host BH by help of a boot computer program stored in a BSAN, the BHBA 31 of a host BH needs to load the boot computer program stored as a boot image in at least one disk array BDA. To this end, the BHBA 31 accesses the SBS 35, where it finds the mapping of virtual volumes VV with an appropriate boot image saved therein, from where direction is provided to a suitable boot image stored in one or more physical storage disk array(s) DAB. Subsequently the BHBA 31 loads the suitable boot image and execution results in the booting of the host HB. All the hosts BH of the BSAN are possibly booted in the same manner.

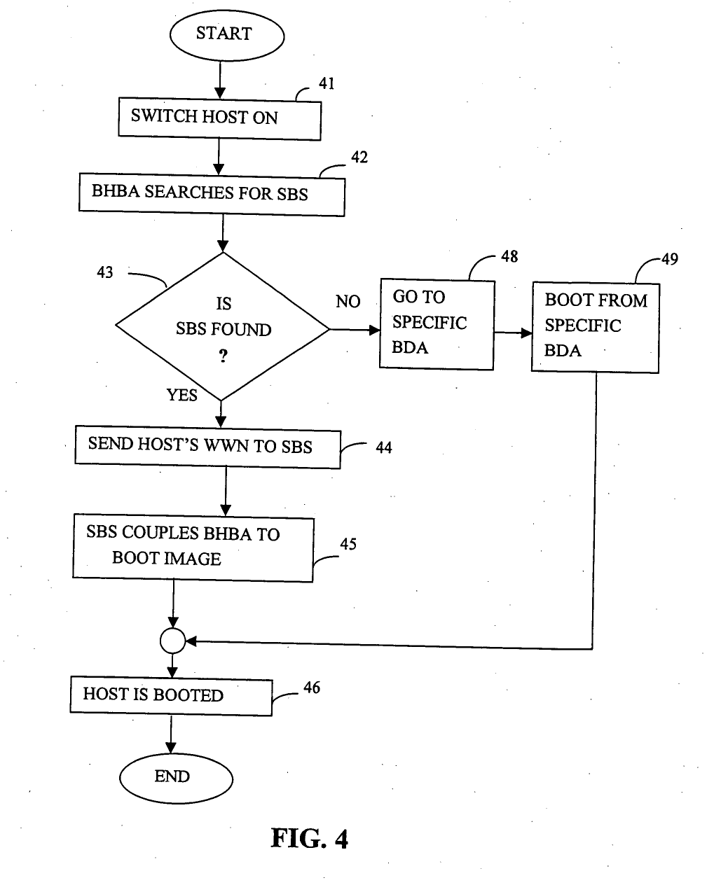

Host booting details are followed by the description of the creation of boot images and of boot templates. The stages required to boot a host HB, which is not equipped with an internal disk 21, from at least one disk array BDA pertaining to a BSAN, necessitate the following list of steps, as shown in FIG. 4.

With reference to FIG. 4, the System Administrator SA operates his System Administrator Workstation SAW and command booting of a host BH.

A. Booting a Host

1. Switch a selected host BH from an off state to an on state, as by step 41 in FIG. 4, whereby the BHBA 31 of the selected host BH becomes operative and searches the SAN-coupled devices, as by step 42, to find a flagged SBS 35. Out of all the SAN-coupled devices, only the SBSs 35 have a dedicated flag signaling presence, which flag is designed to be found by the BHBA 31.

2. When a first flagged SBS 35 is found, as by step 43:

a. the BHBA 31 sends its own WWN identification string to the first found SBS 35, as by step 44,

b. the SBS 35 responds by coupling the BHBA 31, via the virtual boot image mapped in the SBS 35, to an appropriate boot image, as in step 45. The boot image is identified by an ASCII number, and contains the address(es), which are provided as LUN numbers of WWNs of the disk arrays DAB. The boot image contains the computer program(s) necessary for booting.

3. The BHBA 31 boots the selected host BH, by loading the booting computer programs from the boot image. The selected host BH boots, becomes operative, as by step 46, and the boot process ends.

4. If in step 43 no flagged SBS was found then:

a. the BHBA 31 is programmed to access a specific disk array BDA, containing a boot image, the address of which is saved in the BHBA 31, as by step 48, and

b. the selected host BH will boot from the specific disk array BDA, as by step 49.

It is noted that any change entered by a specific host BH to the boot image pertaining thereto will affect only the specific portion of that boot image, and not enter changes whatsoever to the boot template, which is protected as Read Only. Such changes may include, for example, setting an IP address, a host name, or even loading more computer program software pertaining to this specific host BH.

It is further noted that for a host H with an internal disk 21, as shown in FIG. 1, the host H will boot from the internal disk 21, unless the HBA 19 is modified to become a BHBA 31, programmed to first search for an SBS 35. If an SBS 35 is not found, then the host H will boot, either from the internal disk 21, or from a disk array BDA.

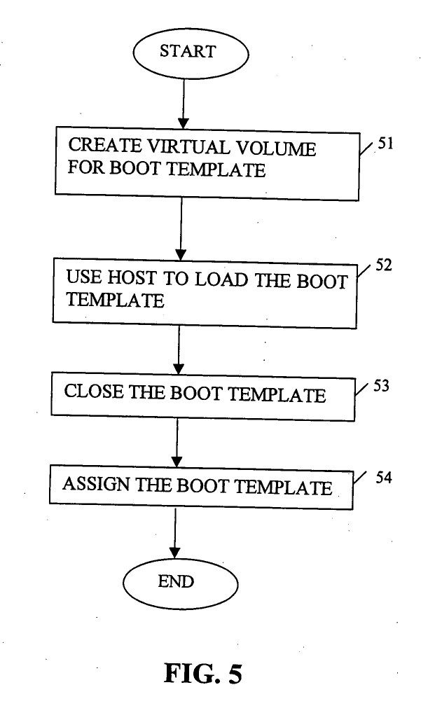

The creation of a boot template necessitates the following steps, as shown in FIG. 5.

B. Creating a Boot Template

As a prerequisite, the System Administrator SA will have to create and identify Virtual Volumes VVs, to be accessed via the SBS 35. The System Administrator SA operates the GUI from his System Administrator SAW, or from a remote workstation, to:

1. Create a virtual volume VV as by step 51, shown in FIG. 5, to become a boot template loaded with the common portion, which is one or more common computer programs required to boot a host BH, either single, or out of a group of hosts BH of the same type.

a. Using the host BH, as by step 52, load from one or more CD-ROMs and into the boot template, those common portion boot computer program(s) necessary to boot that host BH, whereby an Operating System is built, and also load any other necessary computer program(s) common to all the hosts BH. Such computer programs are for example, antivirus, management, and backup software computer programs.

b. Load from the host BH, and into the boot template, additional specific computer programs necessary for booting the selected host BH, and

c. Close the boot template as Read Only, whereby a common portion boot template is created, as by step 53.

2. Assign the boot template, as by step 54, meaning that:

a. The boot template is given an identity by being labeled with an ASCII name chosen by the System Administrator SA.

b. The identified boot template is stored in a disk array BDA. The HBAB 31 of the host HB will have access to the boot template via the SBS 35.

c. The address of the boot template needed for booting the selected host BH is saved in the BIOS of the selected host HB.

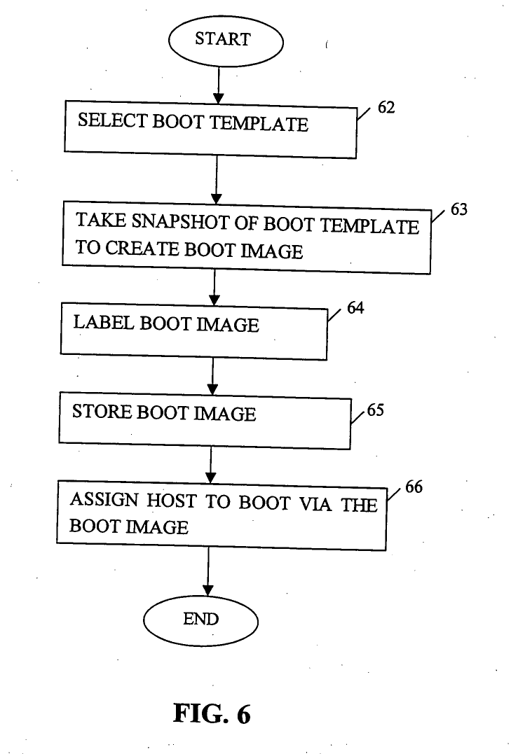

To create a boot image from a boot template, the following steps are required, as shown in FIG. 6. The System Administrator SA operates the GUI from his remote workstation SAW to:

C. Create a Boot Image

a. Select the boot template from which to boot a host BH, as shown in step 62 of FIG. 6.

b. Take a snapshot of the selected boot template, thereby creating a virtual boot image, as by step 63. It is noted that at the time of virtualization, the virtualization layer automatically adds the necessary memory space required for the specific portion. Virtualization via the SBS 35 provides memory space, when necessary, in increased steps of 256 MB, in the same manner of operation as the SVM 3 described in the above-referenced incorporated U.S. Pat. No. 6,898,670.

c. Label the boot image with a selected ACSII number, as by step 64.

d. Store the boot image and store the mapping of the virtual volume in the SBS 35, as by step 65.

e. Assign the host BH that will boot from the boot image, as by step 66, by designating the WWN of the host BH in the boot image so that when the BHBA 31 finds an SBS 35, the host will be linked to the boot image.

The System Administrator SA will complete the assignment process to an individual host BH by booting that host via the assigned boot image, and enter all the necessary data in the host-specific portion. For example, attributes, authorizations, IP address, and data specific to the individual host BH.

One boot image is assigned to each one of the hosts BH.

Patch Control

One of the serious problems encountered in the IT industry is the continuous necessity to add patch updates to the various operative software computer programs such as Operating Systems, device drivers, and other applications programs. This recurring need often creates a dilemma regarding the potential benefits versus the risks incurred with entering modifications to programs currently supplying well working operations. Although the intention is to provide better operational features and to solve future potential problems, the immediate risk associated with entering modifications, which are accompanied by the potential of inflicting damage to the currently running work environment, remains a powerful deterrent. Often large allocations of time and money are spent to test the environment in the attempt to understand the possible implications of those patches to the current production settings. Even after numerous tests, there is a risk involved from the moment a patch is actually applied to production. Often, the new patch turns out to be detrimental, and the efforts devoted to repair the situation and to return to the status prior to the application of the patch, may involve a lengthy and tedious processes. Usually, the facility must be taken down for a few hours, and recovery is achieved only by restoration from tape memory.

The BSAN has the ability to track patches and to instantly roll back boot images, back to the working situation prior to application of the patch. This ability drastically reduces the risks and the time loss associated with patch management, as well as the downtime of the facility, in case the patch does no meet expectations.

By creating an instant copy of the original running boot image, it is possible to apply the patches to the snapshot copy of the boot image, to test the patch in a test environment, and if all runs well, to create a new boot image based on the tested patch as a “new updated image”. Should the patch not work as expected in the test environment or in the production environment, then it is always possible to roll back and return to the original boot image, used prior to the test, and to restore the host BH to the boot situation anterior to the test of the unsatisfactory patch.

After testing and ascertaining that a patch boot image works well on a test host BH, a patch boot image is created and put to work with the production hosts BH. The hosts BH are now rebooted, this time using the patch boot image. Should a host BH not operate properly after the application of the patch boot image, then it is always easy to return to roll back and allocate the original boot image, prior to the test, to those hosts BH for which the patch boot image did not work well, and reboot.

The SBS 35 is advantageous for testing patches provided as new versions of computer programs to be used for booting.

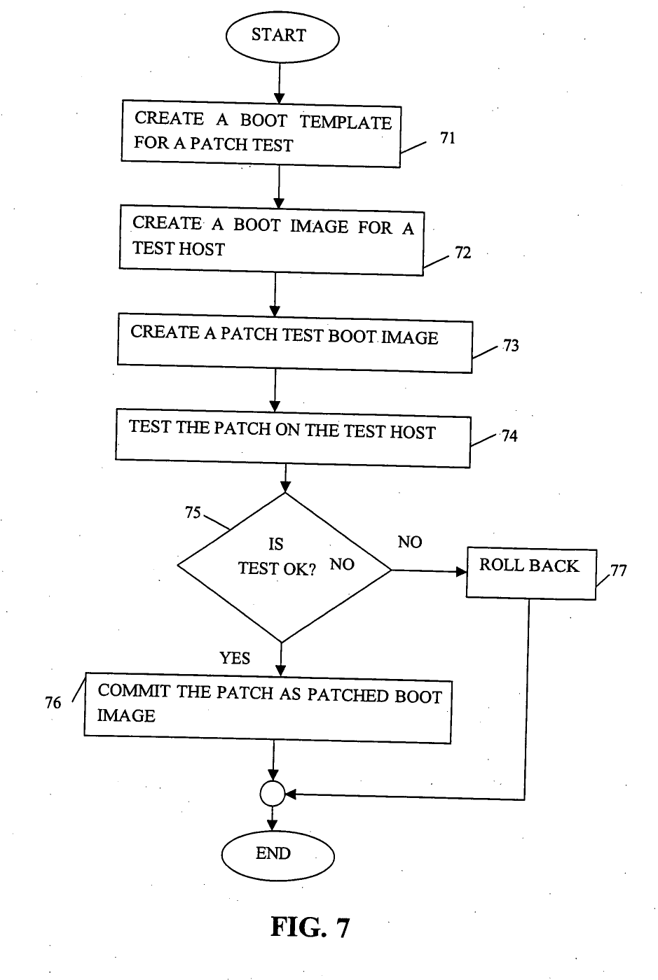

FIG. 7 illustrates, in general terms, the main steps necessary to test a patch in an environment kept separate from production. A patch is a boot computer program supplied by a vendor, and is provided for example, as one or a set of CD-ROMs, for download from a LAN, or from the Internet, or the like.

Advantage is taken from the abilities of the SBS 35, regarding virtualization, creation of virtual volumes, snapshooting, replication, creation of a template and of an image, as describe hereinabove.

With respect to FIG. 7, the system administrator SA operates the GUI on his remote workstation SAW and commands the SBS 35 to:

D. Test a Patch

1. Create a boot template to test a patch on a selected test host BH, as by step 71 in FIG. 7.

2. Create a boot image for a specific test host BH, as in step 72.

3. Create a patch test boot image for the patch to be tested, by adding the patch to be tested to the boot image created in the previous step 72, as shown in step 73.

4. Test the patch test boot image on the test host BH, as in step 74.

5. According to the decision taken in step 75, either

6. Commit the patch test boot image to become a patched boot image and end the procedure if the test is satisfactory, as by step 76, or

7. Roll back and end the procedure if the test is not satisfactory, as by step 77.

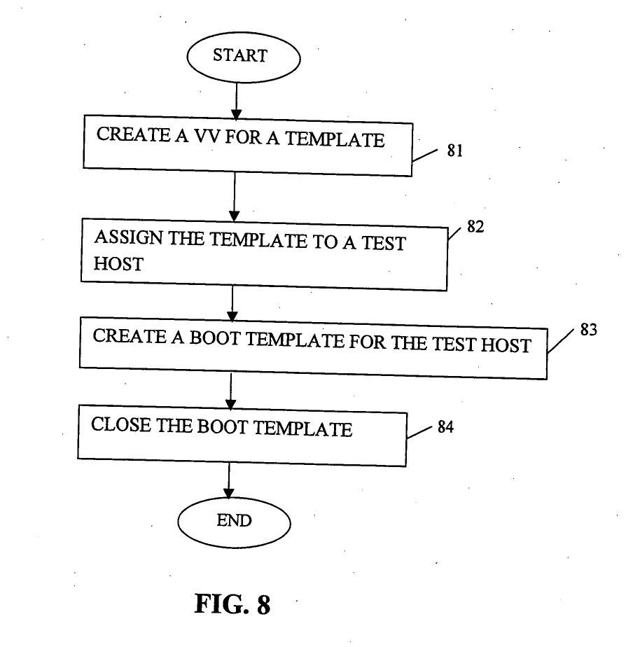

FIGS. 8 to 10 show details of FIG. 7, regarding the steps performed the system administrator SA for testing a patch for a boot computer program, or patch, as illustrated in FIG. 7.

With reference to step 71 of FIG. 7, to create a boot template to test a patch on a selected test host BH, the system administrator SA operates the GUI on his remote workstation SAW and commands the SBS 35, as shown in FIG. 8, to:

a. Create a virtual volume VV for a template, as by step 81,

b. Assign the created virtual volume VV to a test host selected to run the test of a patch, as by step 82. Assignment was described in step 66 hereinabove.

c. Load the O.S. and other computer programs from the selected test host to create a boot template that is Read Only, as by step 83.

d. Close the boot template, and make Read Only, as by step 84.

With reference to step 72 of FIG. 7, to create a boot image specific to a test host BH, the system administrator SA operates the GUI on his remote workstation SAW and commands the SBS 35, as shown in FIG. 9, to:

a. Select the boot template closed in step 84, as shown in step 91.

b. Make a snapshot of the virtual volume containing the boot template that was closed in step 84, as shown in step 92, thereby creating a boot image. The created boot image now contains the boot template as a common portion and the host-specific portion that is dedicated to the test-host.

With reference to step 73 of FIG. 7, to create a patch test boot image, the system administrator SA, operates the GUI on his remote workstation SAW and commands the SBS 35, as shown in FIG. 10, to:

a. Make a snapshot of the boot image created in step 92, as shown in step 101. It is remembered that a snapshot always leaves a free available memory space of at least 256 MB for an anticipated specific portion to be added, and that the virtualization facility of the SBS 35 provides additional required memory space in chunks of 256 MB. This last snapshot thus contains the boot image created in step 92 and a free memory space.

b. Command loading of the patch, as by step 102, say from CD-ROMs, or from the Internet, etc. into the space left free for the anticipated specific portion, thereby creating the patch test boot image. The patch test boot image contains the boot image created in step 92, having a boot template and a first specific portion for the test host, and a second specific portion loaded with the patch.

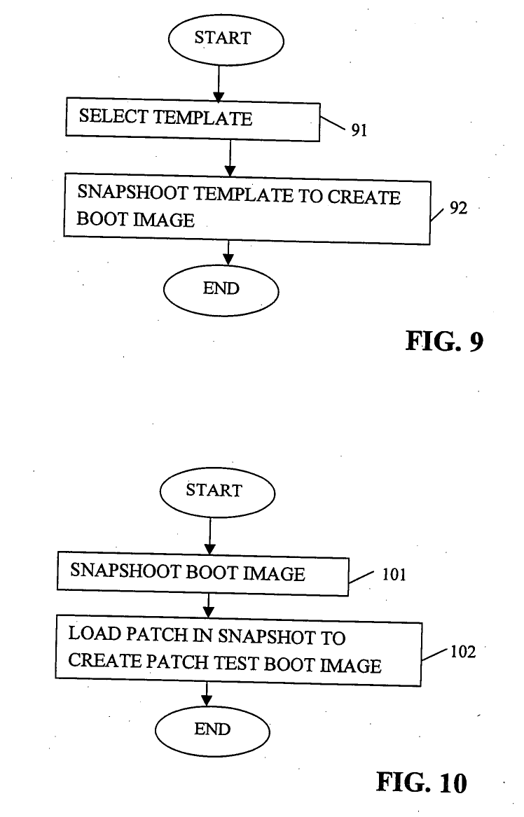

The results of the process described with reference to FIG. 10 are illustrated in FIG. 11, showing the boot image 111 containing the boot template 112 and the test host specific portion 113. The patch 114 and the boot image 111 are both contained in the patch test boot image 115.

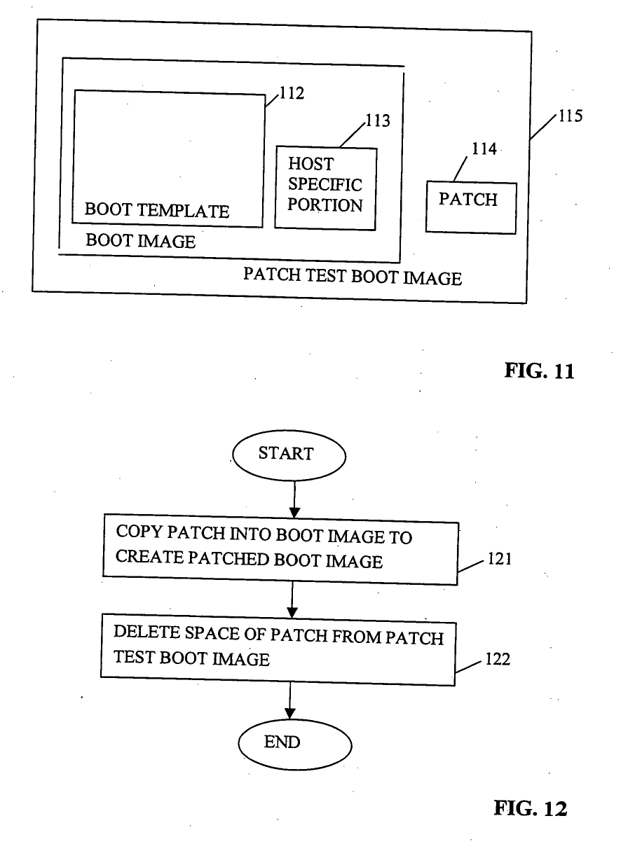

The patch boot image is now tested on the test host BH, as shown in step 74, and if all runs well to satisfaction, as in step 75, the patch is accepted, and becomes a patched boot image. The system administrator SA commands the SBS 35 to commit the patch boot image, as in step 76, shown in detail in FIG. 12, whereby:

a. The SBS 35 starts to copy the data of the patch into the boot image created in step 92, to create a patched boot image, as shown in step 121.

b. Thereafter, the SBS 35 deletes the memory space occupied by the patch in the patch test boot image crated in step 102, as shown in step 122, leaving a patched boot image having a boot template, a host-specific portion for the test host HB, and a patch in a second specific portion.

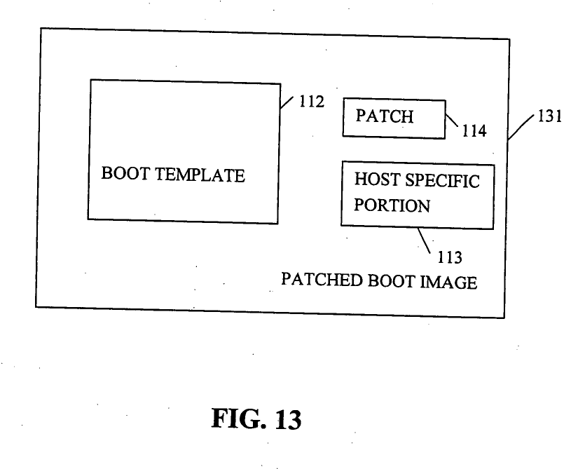

The results of the process described with reference to FIG. 12 are illustrated in FIG. 13, for consideration in contrast with FIG. 11. FIG. 13 shows the patched boot image created in step 121 and now designated as 131, containing the boot template 112, the test host specific portion 113, and the committed patch 114.

If after the test of the patch, shown in step 74, the results are inadequate, then the patch is rejected and the situation is rolled back.

With reference to step 76, to roll back and end the procedure if the test is not satisfactory, the system administrator SA operates the GUI on his remote workstation SAW and command the SBS 35, to reject the patch boot image. This deletes the memory space wherein the patch is saved. Thus, only the boot image operated prior to testing the patch is retained.

The net result is that the boot image points to the one prior to the patch test. Graphically represented, this is equivalent to FIG. 13, but with the patch 114 deleted from the drawing.

After a patch is accepted for one test host BH, which is a host BH out of a group of the same hosts, the tested patch is applied to each one host of the group, without the need to test again for each host. With reference to step 72 of FIG. 7, each host BH is regarded as a test host, but committing the patch, as by step 76, follows step 72.

A system administrator SA may thus operate a workstation SAW that is coupled to a BSAN to run a GUI, which is operated in association with the SBS for allowing booting of the hosts from the BSAN, and for testing and assigning patches for updating host booting computer programs. Furthermore, a host may be booted via a boot image directing to an operative booting computer program, where the GUI is operated to create and test a patched booting computer program providing updates to the operative booting computer program, so that when the test is successful, the operative booting computer program is replaced by the patched booting computer program, which is then committed, and when the test fails, the patched booting computer program is rejected.

The industrial applicability of the SBS 35 and the method of its application are found in the information technology IT industry where SAN systems are in wide use.

It is understood that the method and the BSAN 200 described hereinabove present an SBS and a method with the capability of operating and managing SAN-coupled hosts BH, that when turned on to become operative, are configured to access an SBS wherefrom each host out of the plurality of hosts is directed to a boot image containing common and host-specific computer programs for booting the host. The SBS is equipped with processing means and memory storage means configured for running computer programs for the creation and management of virtual volumes, for snapshooting, for replication, and for mirroring. It was already described hereinabove that it is advantageous to form groups of homogeneous hosts, where each group has at least one group member, and to further couple the SBS to the network switch 15 and to the user network. Mirroring is also advantageous for recovery from a failure. For redundancy purposes, the boot images and the boot computer programs of a local site are asynchronously mirrored to a remote SAN site, in standby and ready for use in case of failure at the local site. Still for the sake of redundancy, at least one additional SBS 35′, that is not shown in the Figs. may be coupled to the SBS 35.

The SBS may thereby store a mapping of virtual volumes 25, with each virtual volume containing one boot image for one host, which is directed by the SBS to at least one storage device storing computer programs for booting the host. The hosts may thus be booted automatically from at least one storage device, when turned on to become operative.

It is practical to dissociate boot computer programs into a common portion and a specific portion, and to provide boot images containing one of both. Hence, a boot image is provided with one common portion directing to a boot template storing a booting computer program common to all members of a group, and one host-specific portion containing data, which is specific to only one single host.

Furthermore, for control of production operations, the SBS is configured for execution of commands, for system management tasks, and for creation of boot templates and of boot images. In addition, there is provided a system administrator's workstation, or a user workstation, coupled to the SBS, operated by a system administrator and running a GUI, as an interface program, for providing management commands is further coupled to the SBS. By application of these facilities, the system administrator is able to immediately create boot templates and boot images, and when quick deployment of additional hosts is required, booting operations are installed remotely from the hosts, and automatic booting of the storage device is made available.

Moreover, the SBS is configured for testing updates, such as patches of booting computer programs, and the system administrator may runs tests of these patches via the SBS, and then decide after the test and according to performance, if to command the SBS to accept and commit tested patches, or to roll-back and reject these patches.

Most useful in an industrial environment is the fact that there is no need to access the hosts, but that the system administrator remains remote from the hosts but remains in full control, especially so when entering commands to the SBS, via the workstation.

It will be appreciated by persons skilled in the art, that the present invention is not limited to what has been particularly shown and described hereinabove. For example, for the sake of redundancy, a plurality of SBSs 35 are coupled to the BSAN in a same or in different coupling configuration. Each SBS 35 is independent and takes care of a group of hosts HB. Rather, the scope of the present invention is defined by the appended claims and includes both combinations and subcombinations of the various features described hereinabove as well as variations and modifications thereof which would occur to persons skilled in the art upon reading the foregoing description.

1. A SAN Boot Server or SBS, operative in association with a host boot SAN or BSAN, comprising a plurality of hosts and of physical storage devices, coupled via network communication links to a network switch, the hosts being further coupled to a user network supporting user workstations, wherein:
the SAN Boot Server, SBS, storing a mapping of virtual volumes, with each virtual volume containing one boot image, the SBS being coupled to the network switch and to the user network,
the hosts being configured to access a virtual boot image when turned on to become operative, and
the boot image directing each host out of the plurality of hosts to at least one storage device storing a booting computer program for booting the host,
whereby the hosts are booted automatically from at least one storage device when turned on to become operative.

2. The SBS according to claim 1, wherein:
hosts coupled to the BSAN are void of an internal disk.

3. The SBS, according to claim 1, wherein:
hosts coupled to the BSAN are booted thereby when configured as either one of both, void of an internal disk and with an internal disk.

4. The SBS, according to claim 1, wherein:
the SBS is flagged for detection and for differentiation,
each host has at least one modified HBA configured to discover a flag of an SBS, and
when turned on to become operative, the at least one modified HBA is configured to search the BSAN for discovery only of an SBS.

5. The SBS, according to claim 1, wherein:
the SBS is flagged for detection and for differentiation,
each host has a modified HBA configured to discover a flag of an SBS, and
when turned on to become operative, each host is configured to search the BSAN for discovery only of an SBS, which directs the HBA to a WWN/LUN address wherein a booting computer program is stored and from which the host is booted.

6. The SBS according to claim 1, wherein when the SBS and the hosts are turned on to become operative, a host is configured to:
search for the SBS, and when the SBS is discovered, to access via virtual volume mapping stored in the SBS, of an appropriate boot image directing to a booting computer program, and
boot from the booting computer program stored in at least one storage device.

7. The SBS, according to claim 1, wherein:
the plurality of hosts includes groups of hosts having group members, and when booting:
each one host out of the plurality of hosts accesses a host-specific boot image, and
each one member of a group shares one same boot template computer program common to the group.

8. The SBS, according to claim 7, wherein:
one SBS is provided for one group of hosts.

9. The SBS, according to claim 1, wherein:
the plurality of hosts includes groups of hosts having group members, and when booting:
each one host out of the plurality of hosts accesses a host-specific boot image,
each boot image has a common portion and a host-specific portion, and
each one member of a group shares the common portion, which is common to all the members of the group.

10. The SBS, according to claim 1, wherein:
the plurality of hosts includes groups of hosts having group members, and when booting:
each one host out of the plurality of hosts accesses a booting computer program having a common portion, which is a template of the boot image, and a host-specific portion, and
each one member of a group shares a common portion, which is common to all the members of the group.

11. The SBS, according to claim 10, wherein:
a single copy of the common portion to which the members of a group have access suffices as the common portion necessary for booting members of the same group.

12. The SBS, according to claim 1, wherein:
when a boot image is unavailable to a host, the host will be directed to boot from a computer program stored in either one of both, at least one storage device coupled to the BSAN, and a disk internal to the host.

13. The SBS, according to claim 1, wherein:
a host coupled to the SBS has a HBA which is modified to search for and discover only an SBS, and to access an appropriate boot image mapping stored therein, the SBS directing to a computer booting program which boots the host,
whereby a host is booted and manual access to the host is avoided.

14. The SBS, according to claim 1, wherein:
the SBS has a first coupling linked to the network switch, and
the SBS has a second coupling selected alone and in combination, from the group consisting of coupling the SBS to the user network, coupling the SBS to an Internet to which the BSAN is also coupled, and coupling the SBS to a workstation.

15. The SBS according to claim 1, wherein:
at least one additional SBS is coupled to the SBS.

16. The SBS according to claim 1, wherein:
the boot images and the boot computer programs are asynchronously mirrored to a remote SAN site.

17. The SBS, according to claim 1, wherein:
a workstation operated by a system administrator and running a GUI, is coupled to the BSAN, and
the GUI is operated in association with the SBS for allowing booting of the hosts from the BSAN, and for testing and assigning patches for updating host booting computer programs.

18. The SBS, according to claim 17, wherein:
a host is booted via a boot image directing to an operative booting computer program,
the GUI is operated to create and test a patched booting computer program providing updates to the operative booting computer program, and
when the test is successful, the operative booting computer program is replaced by the patched booting computer program, which is then committed, and
when the test fails, the patched booting computer program is rejected.

19. A SAN Boot Server or SBS, operative in association with a host boot SAN or BSAN, having:
a plurality of hosts and of storage devices coupled via network communication links to a network switch,
the hosts being further coupled to a user network supporting user workstations, and forming groups of hosts, each group having at least one group member, and
the SBS being coupled to the network switch and to the user network, wherein:
the hosts, when turned on to become operative, are configured to access an SBS wherefrom each host out of the plurality of hosts is directed to a boot image containing common and host-specific computer programs for booting the host,
a mapping of virtual volumes being stored in the SBS, with each virtual volume containing one boot image for one host, which is directed by the SBS to at least one storage device storing computer programs for booting the host,
whereby the hosts are booted automatically from at least one storage device when turned on to become operative.

20. The SBS according to claim 19, wherein:
a boot image has one common portion directing to a boot template storing a booting computer program common to all members of a group, and one host-specific portion containing data which is specific to one host,
the SBS is configured for execution of commands, for system management tasks, and for creation of boot templates and of boot images, and
a workstation, operated by a system administrator running a GUI for providing management commands is further coupled to the SBS,
whereby creation of boot templates and of boot images for quick deployment of additional hosts is available.

21. The SBS according to claim 20, wherein:
the SBS is configured for creation of boot templates and boot images, and for testing patches of booting computer programs, and
the system administrator runs tests of patches via the SBS, and according to performance, commands the SBS to either one of both, accept and commit patches, and roll-back and reject patches.

22. The SBS according to claim 21, wherein:
the system administrator is remote from the hosts when entering commands to the SBS, via the workstation.

23. A method for booting hosts with a SAN Boot Server, or SBS, coupled to a host boot SAN, or BSAN, having a plurality of hosts and of physical storage devices, coupled via network communication links to a network switch, the hosts being further coupled to a user network supporting user workstations,
the method comprising the steps of:
storing a mapping of virtual volumes in the SBS, each virtual volume containing one boot image,
coupling the SBS to the network switch and to the user network, and configuring the hosts to access a virtual boot image when turned on to become operative, and for directing each host out of the plurality of hosts to at least one storage device storing a booting computer program for booting the host,
whereby the hosts are booted automatically from at least one storage device when turned on to become operative.

24. The method, according to claim 23, wherein:
hosts coupled to the BSAN are void of an internal disk.

25. The method, according to claim 23, wherein:
hosts coupled to the BSAN are booted thereby when configured as either one of both, void of an internal disk and with an internal disk.

26. The method, according to claim 23, wherein:
the SBS is flagged for detection and for differentiation,
each host has at least one modified HBA configured to discover a flag of an SBS, and
when turned on to become operative, the at least one modified HBA is configured to search the BSAN for discovery only of an SBS.

27. The method, according to claim 23, wherein:
the SBS is flagged for detection and for differentiation,
each host has a modified HBA configured to discover a flag of an SBS, and
when turned on to become operative, each host is configured to search the BSAN for discovery only of an SBS, which directs the HBA to a WWN/LUN address wherein a booting computer program is stored and from which the host is booted.

28. The method, according to claim 23, wherein when the SBS and the hosts are turned on to become operative, a host is configured to:
search for the SBS, and when the SBS is discovered, to access via virtual volume mapping stored in the SBS, of an appropriate boot image directing to a booting computer program, and
boot from the booting computer program stored in at least one storage device.

29. The method, according to claim 23, wherein:
the plurality of hosts includes groups of hosts having group members, and when booting:
each one host out of the plurality of hosts accesses a host-specific boot image, and
each one member of a group shares one same boot template computer program common to the group.

30. The method, according to claim 29, wherein:
one SBS is provided for one group of hosts.

31. The method, according to claim 23, wherein:
the plurality of hosts includes groups of hosts having group members, and when booting:
each one host out of the plurality of hosts accesses a host-specific boot image,
each boot image-has a common portion and a host-specific portion, and
each one member of a group shares the common portion, which is common to all the members of the group.

32. The method, according to claim 23, wherein:
the plurality of hosts includes groups of hosts having group members, and when booting:
each one host out of the plurality of hosts accesses a booting computer program having a common portion, which is a template of the boot image, and a host-specific portion, and
each one member of a group shares a common portion, which is common to all the members of the group.

33. The method according to claim 23, wherein:
a single copy of the common portion to which the members of a group have access suffices as the common portion necessary for booting members of the same group.

34. The method, according to claim 23, wherein:
when a boot image is unavailable to a host, the host will be directed to boot from a computer program stored in either one of both, at least one storage device coupled to the BSAN, and a disk internal to the host.

35. The method, according to claim 23, wherein:
a host to which the SBS is coupled has a HBA which is modified to search for and discover only an SBS, and to access an appropriate boot image mapping stored therein, the SBS directing to a computer booting program which boots the host,
whereby a host is booted and manual access to the host is avoided.

36. The method, according to claim 23, wherein:
the SBS has a first coupling linked to the network switch, and
the SBS has a second coupling selected alone and in combination, from the group consisting of coupling the SBS to the user network, coupling the SBS to an Internet to which the BSAN is also coupled, and coupling the SBS to a workstation.

37. The method, according to claim 23, wherein:
at least one additional SBS is coupled to the SBS.

38. The method according to claim 23, wherein:
the boot images and the boot computer programs are asynchronously mirrored to a remote SAN site.

39. The method, according to claim 23, wherein:
a workstation operated by a system administrator and running a GUI, is coupled to the BSAN, and
the GUI is operated in association with the SBS for allowing booting of the hosts from the BSAN, and for testing and assigning patches for updating host booting computer programs.

40. The method, according to claim 39, wherein:
a host is booted via a boot image directing to an operative booting computer program,
the GUI is operated to create and test a patched booting computer program providing updates to the operative booting computer program, and
when the test is successful, the operative booting computer program is replaced by the patched booting computer program, which is then committed, and
when the test fails, the patched booting computer program is rejected.

41. A method for operating a SAN Boot Server or SBS) in association with a host boot SAN (BSAN) having a plurality of hosts and of storage devices coupled via network communication links to a network switch,
the hosts being further coupled to a user network supporting user workstations, and forming groups of hosts, each group having at least one group member, and
the SBS being coupled to the network switch and to the user network,
the method comprising the steps of:
configuring the hosts, when turned on to become operative, to access an SBS wherefrom each host out of the plurality of hosts, is directed to a boot image containing common and host-specific computer programs for booting the host, and
storing a mapping of virtual volumes in the SBS, with each virtual volume containing one boot image for one host, which is directed by the SBS to at least one storage device storing computer programs for booting the host,
whereby the hosts are booted automatically from at least one storage device when turned on to become operative.

42. The SBS according to claim 41, wherein:
a boot image has one common portion directing to a boot template storing a booting computer program common to all members of a group, and one host-specific portion containing data which is specific to one host,
the SBS is configured for execution of commands, for system management tasks, and for creation of boot templates and of boot images, and
a workstation, operated by a system administrator running a GUI for providing management commands is further coupled to the SBS,
whereby creation of boot templates and of boot images for quick deployment of additional hosts is available.

43. The SBS according to claim 42, wherein:
the SBS is configured for creation of boot templates and boot images, and for testing patches of booting computer programs, and
the system administrator runs tests of patches via the SBS, and according to performance, commands the SBS to either one of both, accept and commit patches, and roll-back and reject patches.

44. The SBS according to claim 43, wherein:
the system administrator is remote from the hosts when entering commands to the SBS, via the workstation.
